(19) United States
(12) Patent Application Publication
(10) Pub. No.: US 2016/0341583 A1
(43) Pub. Date: Nov. 24, 2016

(54) VIBROACOUSTIC DETERMINATION OF GAS AND SOLIDS FLOW RATES IN GAS CONVEYANCE PIPING

(71) Applicants: John M. Stencel, Lexington, KY (US); Charles Lockert, Carnegie, PA (US)

(72) Inventors: John M. Stencel, Lexington, KY (US); Charles Lockert, Carnegie, PA (US)

(21) Appl. No.: 15/013,203

(22) Filed: Feb. 2, 2016

Related U.S. Application Data
(60) Provisional application No. 62/110,648, filed on Feb. 2, 2015.
(60) Provisional application No. 62/127,395, filed on Mar. 3, 2015.

(51) Int. Cl. G01F 1/66

(52) U.S. Cl. CPC G01F 1/66

(57) ABSTRACT

Methods and systems for measuring a gas flow rate and/or a solids feed rate by detecting a vibroacoustic emission caused by passage of the gases and/or solids through an interior of a pipe are described. The methods include correlating an intensity of a broad-band vibroacoustic emission having a frequency of up to 3,200 Hz with a change in the gas flow rate. The methods also include correlating a change in a position of a narrow-band vibroacoustic emission having a frequency of up to 800 Hz with a change in the solids feed rate. The methods further include correlating the change in the position of the narrow-band vibroacoustic emission with an absolute solids feed rate. The systems include at least one vibroacoustic sensor and at least one computer program product having machine-readable instructions executable on at least one processor for performing the described steps of correlating.

### RELATED APPLICATIONS

This application claims priority to U.S. Provisional Application Ser. No. 62/127,395 filed Mar. 3, 2015, and to U.S. Provisional Application Ser. No. 62/110,648 filed Feb. 2, 2015, the contents of each of which are hereby incorporated by reference in their entirety.

### TECHNICAL FIELD

The present disclosure relates to measurement of gas and solids flow in piping. In particular, the disclosure relates to non-invasive methods for measurement of such gas and solids flow by use of vibroacoustic sensors, and to systems and instrumentation therefor.

### BACKGROUND OF THE INVENTION

Process control instruments (PCI's) are identified by the 2012 North American Industrial Classification System (NAICS) as number 334513—Instruments and Related Products Manufacturing for Measuring, Displaying, and Controlling Industrial Process Variables; the older Standard Industrial Classification number is SIC 3823. The total shipment value of PCI's in the US during 2010 was $7.4 billion, with flow measurement and control instruments constituting one of the largest sources of revenue primarily for industrial processing.

No practicable PCI is commercially available for measuring and controlling dilute phase, turbulent flow, gas conveyance of solids in highly branched systems when piping diameters are less than 15 cm because they cost too much to buy, install or operate, and because they have technology application limitations. In particular, a potentially competitive device would be required to be non-intrusive, because the invention is non-intrusive—meaning no sensor intrudes into or has ‘view’ of the inside of the piping. This limitation restricts competitive possibilities to those based on three different, fundamental instrumentation concepts: a) capacitance; b) triboelectric charge; and c) ultrasonics.

For capacitance measurements (instrumentation a), two specialty designed pipe segments along with the sensor have to be placed within each pipe section to be monitored with up to 20× the pipe diameter straight sections before and after the segments, with the pipe having only vertical orientations: the problems are high costs, difficult installations and technology limitations. For use of triboelectric charge (instrumentation b), humidity levels affect the amount of triboelectric charge generated—most dilute phase, gas conveyance systems do not have humidity controls—and specialty sections of pipe have to be added: the problems are difficult installations, technology limitations and, if humidity levels are controlled, high operational costs. For ultrasonic measurements (instrumentation c), the exterior and interior walls of the piping have to be clean or devoid of deposits or corrosion, and a specialty designed pipe segment along with a sensor have to be placed with up to 20× the pipe diameter straight sections before and after the segments: the problems are high costs, installation difficulties, and technology limitations. Thus, the above-summarized limitations hamper utility of such technology in settings such as commercial power plants.

To address the aforementioned and other issues, the present disclosure teaches methods and devices for non-invasive measurement of gas and solids flow through piping utilizing vibroacoustic sensors. Advantageously, vibroacoustic measurement requires no installation of specialty or vertical piping is needed. Pipe corrosion or with deposits are not an issue. In turn, humidity is not a factor for measurements. Still more, long, straight sections of pipe before or after each sensor are not required. Still yet more, the cost of the required sensors for instrumentation described in the present disclosure is low, especially in contrast to the cost for purchasing and installing the sensors required for prior art technologies. Hence, and particularly for larger installations potentially requiring as many as 50 sensors, the cost advantage of a VPCI would be significant.

### SUMMARY OF THE INVENTION

In accordance with the purposes and advantages of the present invention as described herein, in one aspect a non-invasive method for determining gas and solids flow within piping is described. The method relates to passive vibroacoustic measurements of the flow rates of gas and solids within pipes. In an embodiment, one or more sensors are attached onto the outside surfaces of pipes in which gases or mixtures of gases and solids are conveyed under dilute-phase conditions. Attachment of the vibroacoustic sensors is to be accomplished in a way to establish intimate contact between the sensor(s) detector surface(s) and the pipes outer surface(s). By the described method, both gas and solids flow rates are measured, without requirement of additional measurement instrumentation.

In an embodiment, solids flow rates are determined by detecting characteristic narrow-band vibroacoustic signals having a typical range between the 0-800 Hz acoustic region. Gas flow rates are determined using broad-band vibroacoustic signals having a typical range between 0-10,000 Hz. The solids flow rate data are then used to standardize gas flow rates.

In another aspect, the present disclosure describes a vibroacoustic process control instrument (VPCI) capable of measuring gas and solids flow rates and then providing output signals to be used in a computer system that displays flow rates in a multitude of piping leading to destinations to which the flows are directed and acts in a feedback manner to control conveyance piping hardware that varies or optimizes either, or both, gas and solids flows and their distributions in highly-branched conveyance piping.

The instrument may include one or more vibroacoustic sensors configured for passively detecting vibrations in piping through which gas/solids are conveyed. Passive measurements means that no signal is impressed upon the piping or transmitted into the flow that is then to be detected via intrusive or attached sensors; rather, characteristic signals emanating from the flows of gas and solids and transmitted through the piping are detected via the attached sensors.

In embodiments, the sensors are accelerometers having sensitivity within the audible frequency range (0-10,000 Hz). A variety of accelerometers are contemplated for use, including without limitation piezoelectric resistive accelerometers, micromachined capacitive accelerometers, capacitive spring mass base accelerometers, electromechanical servo accelerometers, laser accelerometers, PIGA, and others. In one embodiment, the sensors are piezoelectric-based accelerometers.

Advantageously, the described instrument is not restricted to particular types of piping. Use of the instrument to measure gas/solids flow rates in PVC, hard-rubber, stainless steel, carbon steel, and other piping is contemplated Likewise, the composition of the gas being measured does not affect the instrument.

The constituency of the solids is also unspecified. In embodiments, flow rates of solids having particle sizes of from about 0.1-500 μm are measured.

In the following description and appended Exhibit there are shown and described several different embodiments, simply by way of illustration of some of the modes best suited to carry out the invention. As it will be realized, the described subject matter is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 shows a commercial power plant including DSI conveyance piping leading to DSI injectors;

FIG. 2 schematically depicts the DSI conveyance piping of the plant of FIG. 1, with locations of positioned vibroacoustic sensors marked;

FIG. 3 shows a vibroacoustic sensor attached to an exterior of piping;

FIG. 4 graphically depicts broad-band vibroacoustic response signals measured with a gas-only flow through the conveyance piping;

FIG. 5 graphically depicts a quadratic equation fit of the broad-band vibroacoustic response signals of FIG. 4;

FIG. 6 graphically depicts broad-band vibroacoustic response signals measured with a gas-only flow through conveyance piping, with an obstructed gas flow;

FIG. 7 graphically depicts broad-band vibroacoustic response signals measured with varying gas flow rate and inclusion of a constant solids flow rate through conveyance piping;

FIG. 8 graphically depicts broad-band vibroacoustic response signals measured with a constant gas flow rate and varying solids flow rate through conveyance piping;

FIG. 9 graphically illustrates a change in vibroacoustic intensity (dB) of conveyance piping wall with increasing gas flow rate or solids flow rate;

FIG. 10 schematically depicts dimensions/geometry of piping for acquisition of vibroacoustic signals to determine solids flow rates;

FIG. 11 graphically illustrates characteristic vibroacoustic peaks of piping wall for a Type 22.5 SPS;

FIG. 12 graphically illustrates changes in frequency of the characteristic vibroacoustic peaks of the SPS piping wall of FIG. 11;

FIG. 13 graphically illustrates accelerometer data from Type 2.25 SPS; and

FIG. 14 illustrates integrated intensities of vibroacoustic signals at increasing solids feeds rates.

Reference will now be made in detail to the present preferred embodiment of the invention, examples of which are illustrated in the accompanying drawings.

### DETAILED DESCRIPTION OF THE INVENTION

To solve the foregoing problems, at a high level the present disclosure is directed to methods for detecting and quantifying gas and solids flow rates through piping are described. In turn, a vibroacoustic process control instrument (VPCI) utilizing vibroacoustic sensors for measuring and controlling the gas conveyance of solids in industrial and manufacturing applications is described. As an entry market segment, the VPCI has been tested at and targets solid reagent delivery in acid gas emission control systems. Gas flow rates tested to date have been between 0-60 m/s, a range typical to a broad range of gas conveyance and other piping/transmission systems.

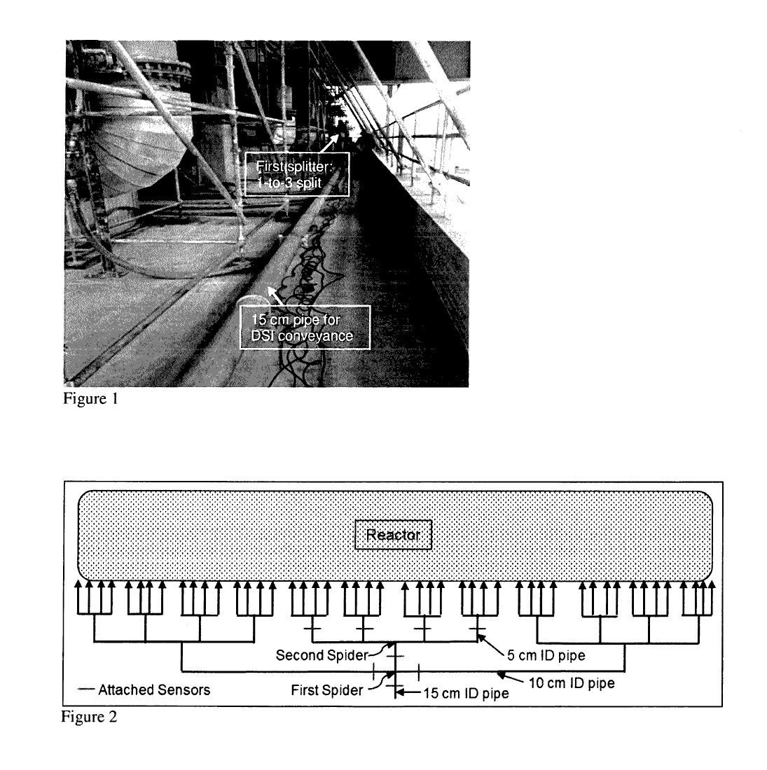

The described methods and instrumentation were evaluated using laboratory-scale and commercial-scale installations. FIG. 1 gives an overview of where data collection occurred at a large commercial energy production plant. That plant uses dry sorbent injection (DSI) to control acid gas emissions from the coal combustion system. During DSI, air and solid reagents are conveyed via piping from a silo/storage area and injected into large-scale reactors. Data for VPCI development was acquired on piping outside of buildings housing the coal combustor and its auxiliary equipment and the steam turbine. The balcony area shown in FIG. 1 offers some protection from rain—because of overhanging plant structure—but no temperature control. It is 45 m above ground level, almost directly above the combustor and next to a deNOₓ reactor, but before the electrostatic precipitator (ESP). Besides collecting data from 5 cm (2.5 inch) ID piping after the first splitter identified in FIG. 1, which is part of the south side injectors after the deNOx reactor, data were also acquired from piping after a second splitter on the south side injectors, from piping after a second splitter on north side injectors, and from piping at the ground level where the sorbent silo and the main, 15 cm diameter feed pipes are located.

The DSI reagent is fed via a gravimetric feeder from a silo, located 18 m from the side of a building on which the balcony is located; attached to the outside of the building are two 15 cm (6 inch) ID diameter pipe risers that convey reagent to the level needed for injection into the reactor. A horizontal pipe (shown in FIG. 1) is connected to the riser, and conveys the reagent approximately 20 m to the first splitter. After this split (1-to-3, and having 10 cm ID diameter piping), the conveyance pipes are split two more times (with, first, a 1-to-4 split having 5 cm diameter piping and then another 1-to-4 split having 2.5 cm diameter piping) before the injectors. The total distance from the silo to the injectors is approximately 110 m. FIG. 2 is a schematic of the DSI conveyance piping for the south side injectors that terminates in 48 injectors; these are located after the de-NOx reactor within the flue gas stream. Twelve DSI injectors are also in place on the north side of the unit; these are located before the de-NOx reactor.

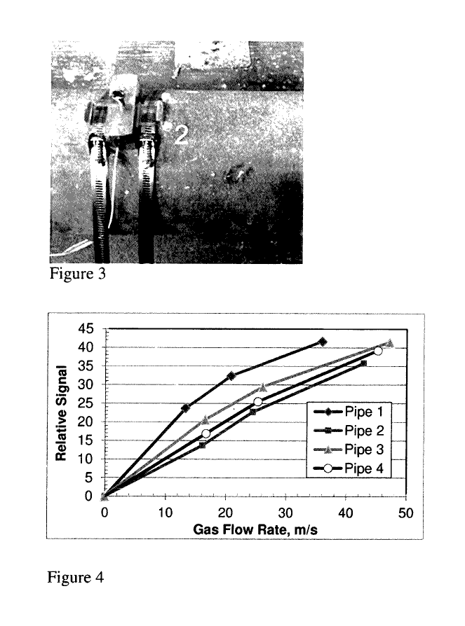

Vibroacoustic data were acquired from 5, 10 and 15 cm (2, 4, and 6 inch) ID piping before and after the first splitter. For comparison, both microphones and accelerometer sensors were used. It will be appreciated that microphones are not required for VPCI instrumentation. However, their use enabled data comparisons and assessments of the veracity of the accelerometer data for control purposes. The piping materials of construction were carbon steel, stainless steel and bendable hard rubber. The accelerometers were attached to DSI conveyance piping, as displayed in FIG. 3, using an easy-to-clamp mechanism with a screw adjustment at the top of the clamp that ensured secure and repeatable contact between the accelerometer's surfaces and the pipes. In FIG. 3, the accelerometer is below the metal holder, and the white wire seen at the lower side of the holder is attached to the accelerometer, i.e. the holder is large in comparison to the accelerometer. The range of variation of conveyance gas flow rates, reagent feed rates, and accelerometer locations are presented in Table 1.

TABLE 1
DSI process parameter ranges and sensor locations
during data acquisition at the power plant.

| Parameter varied | Range |
|---|---|
| Conveyance gas (air) | 0-60 m/s (0-197 f/s) |
| Reagent feed rates | 0-2,400 kg/hr (0-5,280 lb/hr) |
| Sensor locations | 2.5, 5, 10 and 15 cm ID piping (up to 10 sensors) |

Ranges of variation of conveyance gas flow rates, reagent feed rates, and accelerometer locations, or equivalent ranges for the case of reagent feed rates injected through 48 injectors at the commercial plant, were tested during the laboratory-scale and commercial-scale testing. VPCI data acquisition typically occurred during periods ≦5 minutes, and were repeated up to three times each. Gas flow rates were varied independently of reagent feed rates, and they were also varied in tandem.

Besides gas flow rate measurements, the solid reagent flow rates were also measured. Durations of solids collection varied between 2-15 minutes, depending on the overall solids feed rate from the reagent storage silos; the amount of solids collected at each pipe in the commercial-scale tests varied between 2.5-11.2 kg, and was measured using a digital scale having ≦40 kg capacity and 0.001 kg precision; solids collection and measurements were also accomplished during the laboratory testing.

### EXAMPLE 1

A comparison of overall, broad-band (0-3200 Hz) signals from accelerometers 1-4, attached to Pipes 1-4 at the commercial plant, respectively, are presented in FIGS. 4 and 5 for gas flow rates between 0-50 m/s. As gas flow rates were increased, the vibroacoustic signals (defined as “Relative Signals” and in dB—decibels) increased and had a near-linear dependence for Pipes 2 and 4 and weakly quadratic dependence for Pipes 1 and 3. To assess how pipe wall vibrations compare with sound pressure levels within the piping, microphone data were also acquired simultaneously with the accelerometer data but these data are not discussed herein.

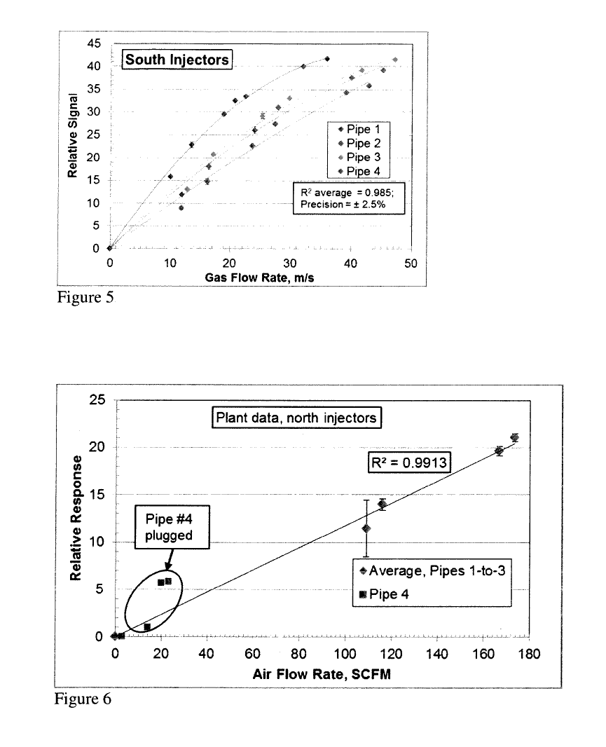

The vibroacoustic responses of accelerometers attached to piping on the north side DSI system at the commercial plant are presented in FIG. 6. In contrast to the weakly quadratic dependence of the vibroacoustic signals displayed in FIG. 5 for pipes leading to the South Side injectors, the data in FIG. 6 show that the pipes leading to the North Side injectors displayed a linear response in the overall broad-band vibroacoustic signal as the air flow rates were increased. In addition, because of very small increases in the Relative Response of the accelerometer on Pipe #4 in FIG. 6 as the air flow rates were increased, the flow through Pipe #4 was determined to be either highly restricted or plugged. Upon informing plant operators of the plugged injector, they sent a repair crew who cleaned the pipe and re-established normal air/sorbent injection operation. Hence, one aspect of the VPCI concept of use for pneumatic conveyance piping is the capacity to distinguish ‘On/Off’ flow situations in which piping has or does not have flow restrictions which hinder conveyance of air and solids into receptacles.

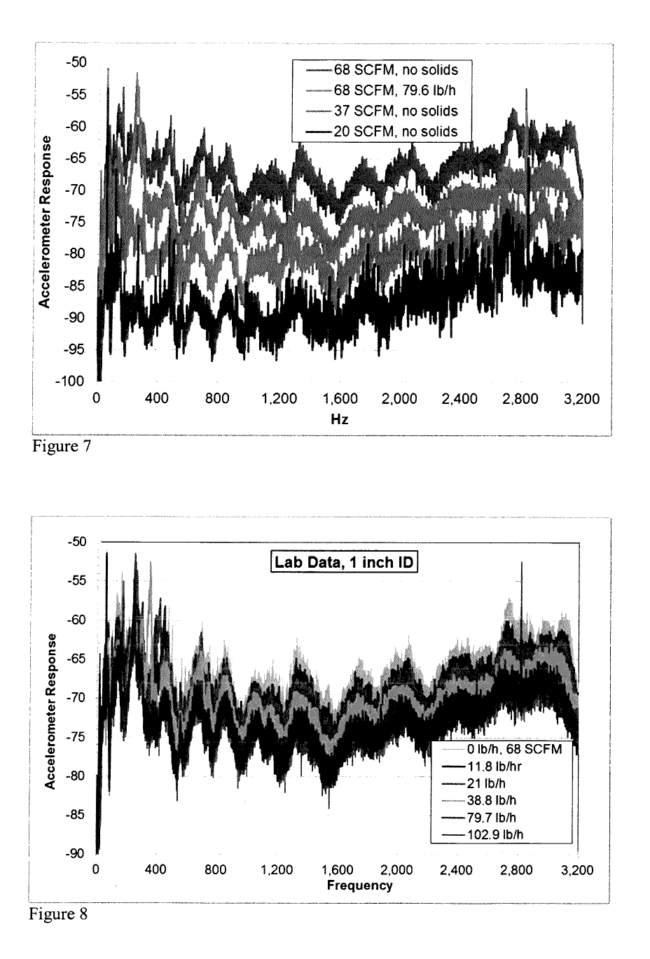

Vibroacoustic data presented in FIGS. 4-6 represent air flow only, i.e. no reagent (solid) was under conveyance. However, it was imperative to measure both air and solids flow rates in DSI systems and other pneumatic conveyance systems to enable efficient and/or wanted flow distributions to occur from the outlets of the highly-branched conveyance piping. Hence, changes in overall broad-band vibroacoustic intensities were assessed as both air flow and solid flow rates were varied during commercial-scale and laboratory-scale tests, data for which are presented in FIGS. 7 and 8.

FIG. 7 displays vibroacoustic intensities (in decibels=dB) between 0-3,200 Hz which decreased by ˜20 dB as the air flow rates were decreased from 69-to-20 SCFM when no solids were under conveyance (larger negative numbers means smaller vibroacoustic intensities). This result is known to any person who would listen to audible sounds emanating from piping in which gas flow is occurring—less audible sound is heard as gas flow rates decrease. Furthermore, the audible sound heard is characteristic of ‘broad-band’ sound in which no dominant tone exists. The data in FIGS. 7 and 8 show that the vibroacoustic signals are also ‘broad-band’, i.e. extend over the entire measurement range of 0-3,200 Hz; accelerometer data with a range of 0-5,000 Hz have also displayed this ‘broad-band’ nature.

However, data in FIG. 7 when the air flow rate was 68 SCFM and solids flow was introduced at 79.6 lb/h (per injector) gave overall (0-3,200 Hz) vibroacoustic intensity levels that were intermediate of that for 68 SCFM without solids and 37 SCFM without solids. In other words, the presence of solids within the conveyance piping dampened the vibration intensities of the piping wall that was caused by gas flow; hence, the presence of solids within conveyance piping dampens acoustic emission caused by gas flow. Furthermore, the data in FIG. 8 show that the overall vibroacoustic signal decreases as more and more mass is added into the flow. These results are a consequence of solids adding mass into the flow which then causes increased sound absorption; no previous reports are known that show the presence of solids causing decreased piping wall vibrations as measured by vibroacoustic sensors attached to piping walls of gas conveyance pipes.

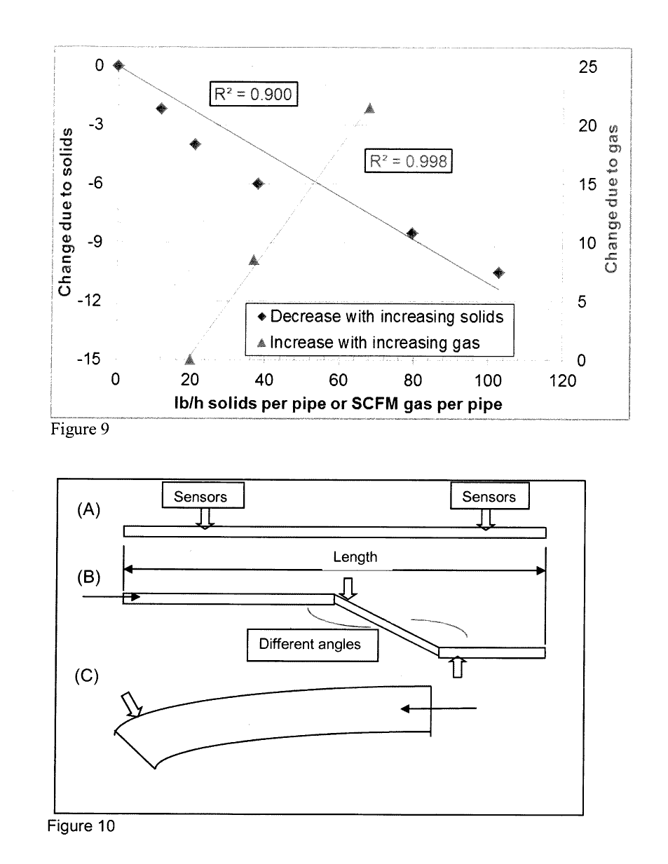

An important aspect of the decrease in broad-band vibroacoustic signal as solids are added to gas flow is that distinguishing between the amount of gas flow versus the amount of solid flow would be nearly impossible by using accelerometers attached to the outside surface of conveyance pipes because increasing solid flows decreases the broad band signal and increasing gas flows increases the broad band signal. That is, it was necessary to give consideration to decoupling gas flow results from solid flow results. To emphasize this point, FIG. 9 show the decreasing vibroacoustic signal with increasing solids flow rates and the increasing vibroacoustic signal with decreasing solids flow rates, i.e. opposing effects that would hamper the use of broad band vibroacoustic intensities by themselves to determine absolute values of gas and solid flow rates. Although the data in FIGS. 7-9 were acquired in a laboratory setting, the laboratory gas and solids flow rates reflect actual commercial plant operational parameters. For example, gas flow rates between 0-68 SCFM in the laboratory represent gas speeds between 0-64 m/s; at the commercial plant, gas speeds were between 0-50 m/s; furthermore, the laboratory data in FIG. 9 of lb/h per pipe would represent solids feed rates between 0-4940 lb/h for the 48 injectors at the commercial plant, whereas actual plant reagent feed rates were between 0-5000 lb/h.

Hence, additional vibroacoustic data were acquired within laboratory and commercial plant settings during the conveyance of gas and solids to assess if other than broad-band signals (as represented by the data in FIGS. 4-through-8) could be extracted by using accelerometers attached to the piping. These assessments established that, indeed, other characteristic vibroacoustic signals are measurable that relate specifically to solids feed rates.

FIG. 10 depicts the geometries and dimensions of the data acquisition scenarios in the laboratory and at the commercial plant for examining vibroacoustic signals associated with solids flow rates. The piping specifically assembled for laboratory testing has been called ‘standard pipe sections’ (SPS's); the piping at the commercial plant was already in-place/under-use and was not altered in its geometry or configuration before accelerometers were mounted.

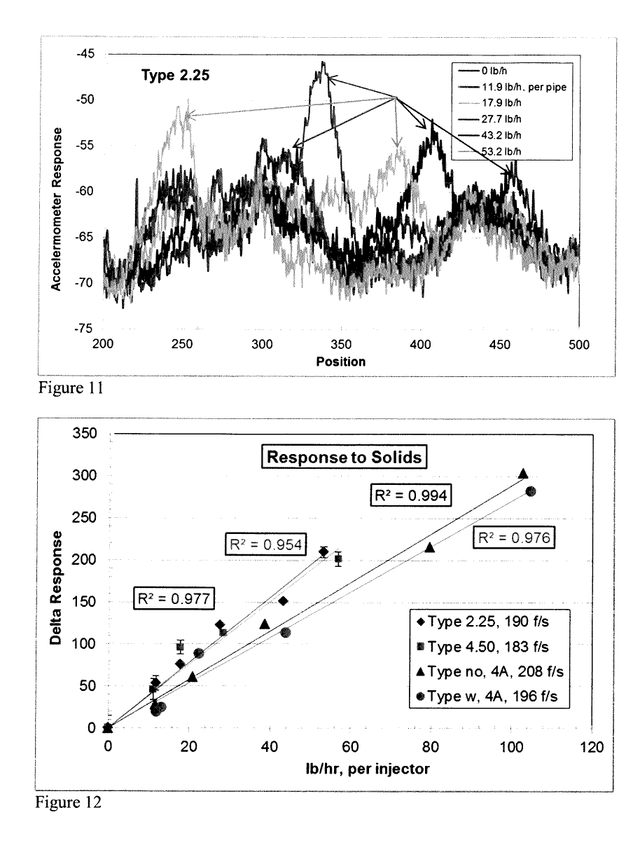

FIG. 11 displays vibroacoustic data acquired in the laboratory from SPS piping having 22.5° elbows with accelerometers placed after the elbows as depicted in FIG. 10; it displays a frequency range between 200-500 Hz. Characteristic and narrow-band (≦25 Hz in halfwidth) vibroacoustic peaks were detected by both accelerometer #1 and #2, and these peak positions changed as the solids feed rates were increased. It was possible to establish from the data shown in FIG. 12 that depict the “Delta-Response”-versus-feed rate for each SPS configuration. The plots for all SPS configurations can be represented by linear functions and, within precision limits of the data, the results for the Type 22.5 and Type 45.0 SPS's were identical but distinct from the data for the linear SPS's. In other words, the slopes of the Type 22.5 and Type 45.0 are identical, within data precision, but were greater than the slopes of the linear SPS's; similarly, the slopes of the linear SPS's were identical, within precision limitations.

From the data in FIGS. 11 and 12, it was possible to conclude that:
1. Solids feed rates within gas conveyance piping can be obtained using accelerometers attached onto the outer surface of SPS piping;
2. The vibroacoustic signal characteristics associated with changing solids feed rates are narrow-band, the positions of which can be used to determine absolute feed rates;
3. These narrow-band vibroacoustic signals at different solids feed rates are distinct from the broad-band signals associated with gas flow;
4. By knowing the solids flow rates (FIG. 12) and the extent to which solids flows decrease broad-band vibroacoustic signal (FIG. 9), it is then possible to standardize broad-band vibroacoustic signals to determine absolute gas flow rates.

Therefore, the use of standard pipe sections (SPS) in dilute phase, gas conveyance piping provides a means to standardize vibroacoustic signals such that both gas and solids flow rates are measurable using accelerometers attached onto the outside surfaces of the conveyance piping. These SPS's can be readily installed into existing piping configurations used in DSI and other gas/solids conveyance systems described in the following; their installation can also be pre-planned into conveyance systems under design and construction.

### EXAMPLE 2

Besides the SPS data in which changing frequency positions of characteristic vibroacoustic bands were found as solid flow rates were increased, another approach to determine solids flow rates independent of gas flow rates has been discovered. Data associated with this second method for determining solids flow rates are presented in the following.

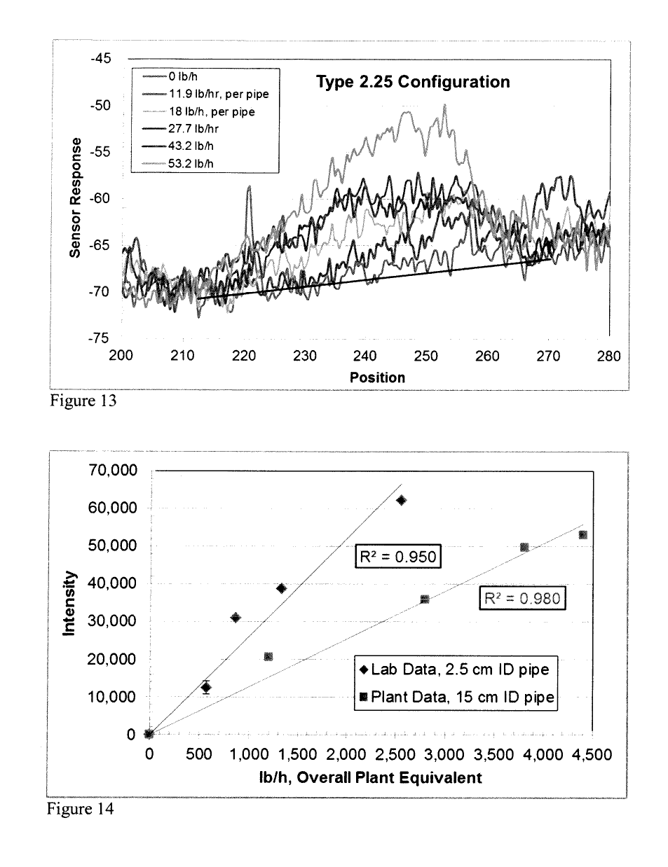

FIG. 13 is an expanded view of a vibroacoustic region for the Type 22.5 SPS laboratory-scale testing as the solids flow rates were increased; here, the intensities of a narrow-band region were observed to continuously increase as the solids flow rates were increased. These changing intensities were taken advantage of by examining and calculating baselines for each of the different solids flow rate cases. It is then possible to integrate the intensities between the baselines and the actual accelerometer signals. Intensities were calculated within each range and included either: A) multiplying the frequency (Hz) position times the intensity at that frequency position and then adding these products over the range of integration; or B) using the accelerometer-based acceleration level (in dB=Lₚₙ) at each frequency data point (n=1-to-N) and summing these over the entire frequency range by using the following equation:

$${L}_{{P}_{tot}} = 10 log {\sum }_{n = 1}^{N} {10}^{{L}_{pn} / 10} .$$

A plot of intensities-versus-solids flow rates (lb/h) is presented in FIG. 14. In agreement with the conclusions from the data in FIGS. 11 and 12, implications of the data in FIG. 14 are that:
1. Solids feed rates within gas conveyance piping can be obtained using accelerometers attached onto the outer surface of SPS piping;
2. The vibroacoustic signal characteristics associated with changing solids feed rates are narrow-band, the intensities within which can be used to determine absolute feed rates;
3. These narrow-band vibroacoustic signals at different solids feed rates are distinct from the broad-band signals associated with gas flow;
4. By knowing the solids flow rates (FIG. 14) and the extent to which solids flows decrease broad-band vibroacoustic signal (FIG. 9), it is then possible to standardize broad-band vibroacoustic signals to determine absolute gas flow rates.

The foregoing description has been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims and Exhibit when interpreted in accordance with the breadth to which they are fairly, legally and equitably entitled. In turn, the drawings and preferred embodiments do not and are not intended to limit the ordinary meaning of the claims in their fair and broad interpretation in any way when interpreted in accordance with the breadth to which they are fairly, legally and equitably entitled.

1. A method for measuring a gas flow rate and/or a solids feed rate, comprising detecting a vibroacoustic emission caused by passage of the gases and/or solids through an interior of a pipe.

2. The method of claim 1, further including correlating an intensity of a broad-band vibroacoustic emission having a frequency of up to 3,200 Hz caused by passage of the gases and/or solids with a change in the gas flow rate.

3. The method of claim 1, further including correlating a change in a position of a narrow-band vibroacoustic emission having a frequency of up to 800 Hz caused by passage of the gases and/or solids with a change in the solids feed rate.

4. The method of claim 3, further including correlating a change in a position of a narrow-band vibroacoustic emission having a frequency of from about 200 to about 500 Hz caused by passage of the gases and/or solids with the change in the solids feed rate.

5. The method of claim 4, further including correlating the change in the position of the narrow-band vibroacoustic emission caused by passage of the gases and/or solids with an absolute solids feed rate.

6. The method of claim 5, further including determining a change in the intensity of the broad-band vibroacoustic emission caused by increasing an amount of the solid passing through the interior of the pipe.

7. The method of claim 6, including determining an absolute gas flow rate from the absolute solids feed rate and the change in the intensity of the broad-band vibroacoustic emission.

8. The method of claim 2, further including correlating a change in an intensity of a narrow-band vibroacoustic emission having a frequency of from about 200 to about 280 Hz caused by passage of the gases and/or solids with a change in the solids feed rate.

9. The method of claim 1, including detecting the vibroacoustic emission using at least one vibroacoustic sensor.

10. The method of claim 9, wherein the vibroacoustic sensor is an accelerometer.

11. The method of claim 9, including detecting the vibroacoustic emission by a plurality of vibroacoustic sensors.

12. A system for determining a flow rate of a gas-solid mixture passing through an interior of a gas conveyance pipe, comprising one or more vibroacoustic sensors adapted to be secured to an outer surface of the gas conveyance pipe, the one or more vibroacoustic sensors being configured to transmit a signal representative of a vibroacoustic emission to a computing device having at least one processor and at least one memory.

13. The system of claim 12, including a plurality of vibroacoustic sensors.

14. The system of claim 13, wherein the vibroacoustic sensors are accelerometers.

15. The system of claim 12, further including at least one computer program product having machine-readable instructions executable on the at least one processor for correlating an intensity of a broad-band vibroacoustic emission having a frequency of up to 3,200 Hz with a change in the gas flow rate.

16. The system of claim 12, wherein the computer program product includes machine-readable instructions executable on the at least one processor for correlating a change in a position of a narrow-band vibroacoustic emission having a frequency of up to 800 Hz caused by passage of the gas-solid mixture with a change in the solids feed rate.

17. The system of claim 16, wherein the computer program product includes machine-readable instructions executable on the at least one processor for correlating a change in a position of a narrow-band vibroacoustic emission having a frequency of from about 200 to about 500 Hz caused by passage of the gas-solid mixture with the change in the solids feed rate.

18. The system of claim 17, wherein the computer program product includes machine-readable instructions executable on the at least one processor for correlating a change in the position of the narrow-band vibroacoustic emission caused by passage of the gas-solid mixture with an absolute solids feed rate.

19. The system of claim 18, wherein the computer program product includes machine-readable instructions executable on the at least one processor for correlating a change in the intensity of the broad-band vibroacoustic emission caused by passage of the gas-solid mixture with an increased amount of the solid passing through the interior of the pipe.

20. The system of claim 19, wherein the computer program product includes machine-readable instructions executable on the at least one processor for determining an absolute gas flow rate from the absolute solids feed rate and the change in the intensity of the broad-band vibroacoustic emission caused by passage of the gas-solid mixture.

21. The system of claim 13, wherein the computer program product includes machine-readable instructions executable on the at least one processor for correlating a change in an intensity of a narrow-band vibroacoustic emission having a frequency of from about 200 to about 280 Hz caused by passage of the gas-solid mixture with a change in the solids feed rate.
